(19) United States
(12) Patent Application Publication
(10) Pub. No.: US 2014/0035789 A1
(43) Pub. Date: Feb. 6, 2014

(54) MULTI-BAND ANTENNA

(71) Applicants: YA CHUNG YU, Taipei (TW); Chih Min Lin, Yangmei (TW); Chih Wei Lin, Yangmei (TW)

(72) Inventors: YA CHUNG YU, Taipei (TW); Chih Min Lin, Yangmei (TW); Chih Wei Lin, Yangmei (TW)

(73) Assignee: SJ ANTENNA DESIGN, Taipei City (TW)

(21) Appl. No.: 13/598,613

(22) Filed: Aug. 29, 2012

(30) Foreign Application Priority Data
Aug. 1, 2012 (TW) 101214939

(51) Int. Cl. H01Q 5/00

(52) U.S. Cl. 343/767; 343/700 MS; 343/819

(57) ABSTRACT

A multi-band antenna is provided in the present invention. The multi-band antenna includes a substrate, a first antenna module and a second antenna module. The first antenna module with an Industrial Scientific Medical band is formed on the substrate. The second antenna module with a V band is formed on the first antenna module. A vertical projecting plane of the second antenna module on the substrate is overlapped with the substrate. The second antenna module further includes at least two antenna units. Center lines of the antenna units are coplanar and are parallel each other with a distance or crossed at a point with an included angle. A height of each antenna unit is equal to an odd multiple of one-quarter effective wavelength.

### CROSS-REFERENCE TO RELATED APPLICATION(S)

This application claims the priority benefit of Taiwan application serial No. 101214939, filed on Aug. 1, 2012. The entirety of the above-mentioned patent application is hereby incorporated by reference herein and made a part of this specification.

### FIELD OF THE INVENTION

The present invention relates to an antenna, and more particular to a multi-band antenna.

### BACKGROUND OF THE INVENTION

Due to the rapid development on wireless transmission systems, many new products must have the performance of wireless transmission so as to meet the consumer's requirement. Antenna is an important element for transmitting and receiving electromagnetic wave energy in the wireless transmission system. The wireless transmission system can not transmit and receive data without the antenna. Thus, the antenna is an indispensable element related to a whole performance of the wireless communication system.

Generally, the antennas are grouped into isotropic antennas, omni-directional antennas and directive antennas according to directivities thereof. Wherein, the directive antenna can transmit and receive electromagnetic energy of a specific direction, so that it can be widely used in fixed direction-based wireless communication systems. In addition, considerations have to be taken when the antenna is designed according to different frequency bands used in different countries. The commonly used specifications of frequency bands include IEEE 802.11, the most popular bluetooth communication (IEEE 802.15.1), and the like. The bluetooth works at a frequency band of 2.4 GHz. IEEE 802.11 is further divided into 802.11a, 802.11b and 802.11g, wherein the 802.11a specification corresponds to a frequency band of 5 GHz, and the 802.11b and 802.11g specifications correspond to a frequency band of 2.4 GHz. A high speed transmission application for high definition digital video operating at a frequency of 60 GHz and transmitting data at a rate of 20 Gbit/sec is considered to be an indispensable transmission module in the future mobile telecommunication and adopted in the specification of 802.11ad.

In order to satisfy the requirements for integrating the wireless transmission systems in the future, the antenna of the mobile telecommunication has to cover an Industrial Scientific Medical (ISM) band with center frequencies 2.4 GHz and 5 GHz and a V band with center frequency 60 GHz. Due to most antennas of different systems in the mobile telecommunication module are distributed type, the volume of the antenna would increase obviously with the amount of antenna while the protocol of mobile telecommunication are extended. Furthermore, the resonant frequencies between the low frequency antenna and high frequency antenna are quite different, the efficiency of mobile telecommunication would be influenced while scaling the volume of the antenna down, which makes the integration of the antennas become more difficult. Therefore, a multi-band antenna which integrates a low frequency antenna with center frequencies 2.4 GHz and 5 GHz and a high frequency antenna with a center frequency 6 GHz together is needed.

For overcoming the mentioned disadvantage of prior art above, a novel multi-band antenna is provided in the present invention.

### SUMMARY OF THIS INVENTION

The main aspect of the present invention is to provide a multi-band antenna through which an ISM band antenna module with center frequencies 2.4 and 5 GHz and a V band antenna module with a center frequency 60 GHz would be integrated together, so that the wireless transmission system would be miniaturized.

In accordance with the aspect of the present invention, the multi-band antenna includes a substrate, a first antenna module and a second antenna module. The first antenna module with an ISM band is formed on the substrate. The second antenna module with a V band is formed on the first antenna module. A vertical projecting plane of the second antenna module on the substrate is overlapped with the substrate.

In accordance with another aspect of the present invention, the multi-band antenna includes a substrate, a first antenna module and a second antenna module. The first antenna module with an ISM band is formed on the substrate. The second antenna module with a V band is formed on the first antenna module. The second antenna module further includes at least two antenna units. Center lines of the antenna units are coplanar and are parallel each other with a distance or crossed at a point with an included angle. A height of each the antenna unit is equal to an odd multiple of one-quarter effective wavelength.

In accordance with further aspect of the present invention, the multi-band antenna includes a substrate, an ISM band antenna module and a V band antenna module. The substrate includes a plurality of first via holes and a first perfect electric conducting (PEC) layer. The ISM band antenna module is formed on the substrate. The V band antenna module is formed on the ISM band antenna module and includes a plurality of second via holes and a second PEC layer. The V band antenna module further includes at least two antenna units. Center lines of the antenna units are coplanar and are parallel each other with a distance or crossed at a point with an included angle. A height of each the antenna unit is equal to an odd multiple of one-quarter effective wavelength.

The above contents and advantages of the present invention will become more readily apparent to those ordinarily skilled in the art after reviewing the following detailed descriptions and accompanying drawings, in which:

### BRIEF DESCRIPTION OF THE DRAWINGS

FIG. 1 is a cross-section view schematically illustrating a multi-band antenna according to a preferred embodiment of the present invention; and

FIGS. 2A and 2B are vertical views schematically illustrating the antenna units of the multi-band antenna according to the preferred embodiment of the present invention.

### DETAILED DESCRIPTION OF THE PREFERRED EMBODIMENT

The present invention will now be described more specifically with reference to the following embodiments. It is to be noted that the following descriptions of preferred embodiments of this invention are presented herein for purpose of illustration and description only, it is not intended to be exhaustive or to be limited to the precise form disclosed.

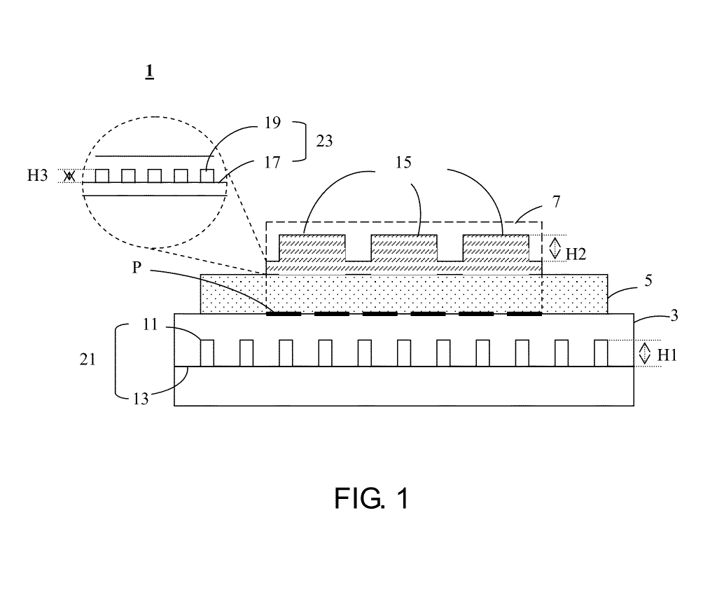

Please refer to FIG. 1, which schematically shows a cross-section view of the multi-band antenna according to a preferred embodiment of the present invention. As shown in FIG. 1, the multi-band antenna 1 includes a substrate 3, a first antenna module 5 and a second antenna module 7. The substrate 3 is a printed circuit board (PCB) or a low-temperature co-fired ceramics (LTCC). The first antenna module 5 is formed on the substrate 3 and has an ISM band. Thus the first antenna module 5 is an ISM band antenna module. The second antenna module 7 is formed on the first antenna module 5 and has a V band. Thus the second antenna module 7 is a V band antenna module. A vertical projecting plane P of the second antenna module 7 on the substrate 3 is overlapped with the substrate 3. The substrate 3 further includes a plurality of first via holes 11 and a first PEC layer 13. A depth H1 of each the first via hole 11 is equal to an odd multiple of one-quarter effective wavelength. The first via holes 11 and the first PEC layer 13 are combined as a first artificial magnetic conductor (AMC) 21. Center frequencies of the first antenna module are equal to 2.4 and 5 GHz, and a radiation pattern thereof is omni-directional. The first antenna module 5 is Global System for Mobile Communications (GSM), Universal Mobile Telecommunications System (UMTS), Wireless Fidelity (WiFi) or Long Term Evolution (LTE). A center frequency of the second antenna module 7 is equal to or larger than 60 GHz, and a radiation pattern thereof is endfired or broadside. The second antenna module 7 is a tapered slot antenna, a yagi antenna or a patch antenna.

According to FIG. 1, the second antenna module 7 further includes at least two antenna units 15, a second PEC layer 17 and a plurality of second via holes 19. The second via holes 19 are formed between the antenna units 15 and the second PEC layer 17. A height H2 of each the antenna unit 15 and a depth H3 of each the second via hole 19 are equal to an odd multiple of one-quarter effective wavelength. The second via holes 19 and the second PEC layer 17 are combined as a second AMC 23, which would decrease the signal coupling interference between the first antenna module 5 and the second antenna module 7.

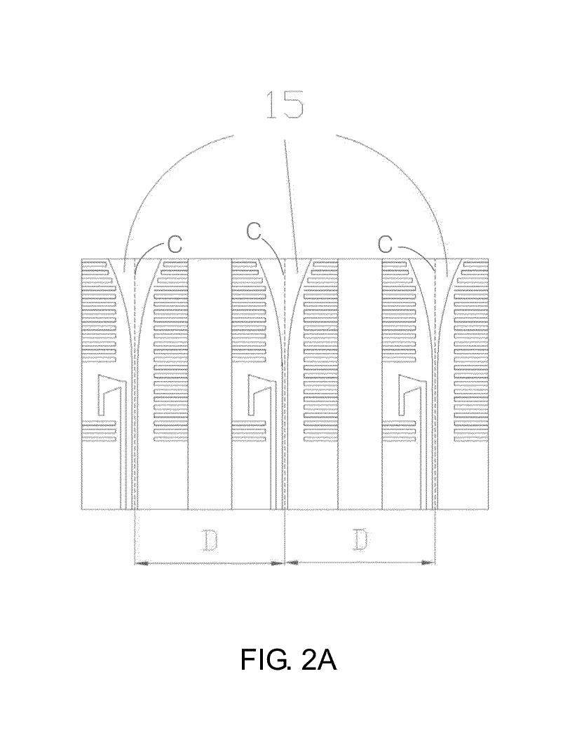

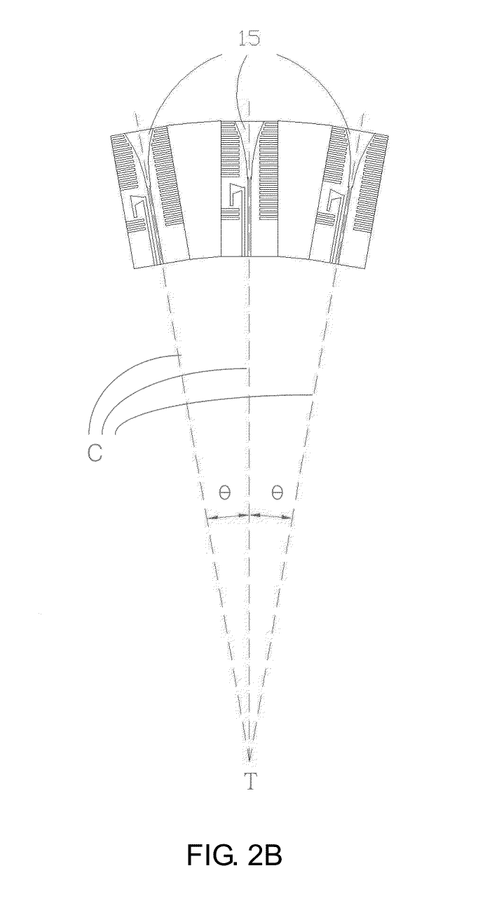

Please refer to FIGS. 2A and 2B, which schematically show vertical views of the antenna units of the multi-band antenna according to the preferred embodiment of the present invention. The symbols used in FIGS. 2A and 2B are same as FIG. 1. As shown in FIG. 2A, center lines C of the antenna units 15 are coplanar (not shown) and are parallel each other with a distance D. The distance D is in a range of one-half effective wavelength and full effective wavelength. The preferred distance D in the present invention is one-half effective wavelength. As shown in FIG. 2B, the center lines C of the antenna units 15 are coplanar (not shown) and are crossed at a point T with an included angle θ. The included angle θ is in a range of 5° and 90°. The preferred included angle θ in the present invention is 15°.

As the above, a multi-band antenna is provided in the present invention. The multi-band antenna combines the first antenna module with ISM band and the second antenna module with V band. The multi-band antenna integrates a high frequency antenna and a low frequency antenna together. Thus, the utilization of the substrate in the multi-band antenna would be improved and the size of the wireless transmission system therewith would be miniaturized to meet the miniaturization trend of the current electrical device. In addition, the signal coupling interference between the first antenna module and the second antenna module would be depressed due to the efficiencies of the first AMC of the substrate and the second AMC of the second antenna module.

While the invention has been described in terms of what is presently considered to be the most practical and preferred embodiment, it is to be understood that the invention needs not be limited to the disclosed embodiment. On the contrary, it is intended to cover various modifications and similar arrangements included within the spirit and scope of the appended claims which are to be accorded with the broadest interpretation so as to encompass all such modifications and similar structures.

What is claimed is:

1. A multi-band antenna, comprising:
a substrate;
a first antenna module with an Industrial Scientific Medical band forming on the substrate; and
a second antenna module with a V band forming on the first antenna module;
wherein a vertical projecting plane of the second antenna module on the substrate is overlapped with the substrate.

2. The multi-band antenna as claimed in claim 1, wherein the substrate is a printed circuit board or a low-temperature co-fired ceramics.

3. The multi-band antenna as claimed in claim 1, wherein the substrate further comprises a plurality of first via holes.

4. The multi-band antenna as claimed in claim 3, wherein a depth of each the first via hole is equal to an odd multiple of one-quarter effective wavelength.

5. The multi-band antenna as claimed in claim 3, wherein the substrate further comprises a first perfect electric conducting layer.

6. The multi-band antenna as claimed in claim 5, wherein the first via holes and the first perfect electric conducting layer are combined as a first artificial magnetic conductor.

7. The multi-band antenna as claimed in claim 1, wherein center frequencies of the first antenna module are equal to 2.4 and 5 GHz.

8. The multi-band antenna as claimed in claim 1, wherein a center frequency of the second antenna module is equal to or larger than 60 GHz.

9. The multi-band antenna as claimed in claim 1, wherein the second antenna module further comprises at least two antenna units.

10. The multi-band antenna as claimed in claim 9, wherein center lines of the antenna units are coplanar.

11. The multi-band antenna as claimed in claim 10, wherein the center lines of the antenna units are parallel each other with a distance.

12. The multi-band antenna as claimed in claim 11, wherein the distance is in a range of one-half effective wavelength and full effective wavelength.

13. The multi-band antenna as claimed in claim 11, wherein the distance is one-half effective wavelength.

14. The multi-band antenna as claimed in claim 10, wherein the center lines of the antenna units are crossed at a point with an included angle.

15. The multi-band antenna as claimed in claim 14, wherein the included angle is in a range of 5° and 90°.

16. The multi-band antenna as claimed in claim 14, wherein the included angle is 15°.

17. The multi-band antenna as claimed in claim 9, wherein a height of each the antenna unit is equal to an odd multiple of one-quarter effective wavelength.

18. The multi-band antenna as claimed in claim 1, wherein the second antenna module further comprises a second perfect electric conducting layer.

19. The multi-band antenna as claimed in claim 18, wherein the second antenna module further comprises a plurality of second via holes.

20. The multi-band antenna as claimed in claim 19, wherein the second via holes are formed between the antenna units and the second perfect electric conducting layer.

21. The multi-band antenna as claimed in claim 19, wherein a depth of each the second via hole is equal to an odd multiple of one-quarter effective wavelength.

22. The multi-band antenna as claimed in claim 19, wherein the second via holes and the second perfect electric conducting layer are combined as a second artificial magnetic conductor.

23. The multi-band antenna as claimed in claim 1, wherein the first antenna module is Global System for Mobile Communications, Universal Mobile Telecommunications System, Wireless Fidelity or Long Term Evolution.

24. The multi-band antenna as claimed in claim 1, wherein a radiation pattern of the first antenna module is omni-directional.

25. The multi-band antenna as claimed in claim 1, wherein the second antenna module is a tapered slot antenna, a yagi antenna or a patch antenna.

26. The multi-band antenna as claimed in claim 1, wherein a radiation pattern of the second antenna module is endfired or broadside.

27. A multi-band antenna, comprising:
a substrate;
a first antenna module with an ISM band forming on the substrate; and
a second antenna module with a V band forming on the first antenna module;
wherein the second antenna module further comprises at least two antenna units, center lines of the antenna units are coplanar and are parallel each other with a distance or crossed at a point with an included angle, and a height of each the antenna unit is equal to an odd multiple of one-quarter effective wavelength.

28. A multi-band antenna, comprising:
a substrate having a plurality of first via holes and a first perfect electric conducting layer;
an ISM band antenna module forming on the substrate; and
a V band antenna module having a plurality of second via holes and a second perfect electric conducting layer and forming on the ISM band antenna module;
wherein the V band antenna module further comprises at least two antenna units, center lines of the antenna units are coplanar and are parallel each other with a distance or crossed at a point with an included angle, and a height of each the antenna unit is equal to an odd multiple of one-quarter effective wavelength.
